(19) United States
(12) Patent Application Publication
(10) Pub. No.: US 2025/0138504 A1
(43) Pub. Date: May 1, 2025

(54) MULTI-HOST SYSTEM AND METHOD FOR DETERMINING A MAIN CONTROLLER

(71) Applicant: Fulian Precision Electronics (Tianjin) Co., LTD., Tianjin (CN)

(72) Inventor: LI-YUN HAO, Tianjin (CN)

(21) Appl. No.: 18/530,679

(22) Filed: Dec. 6, 2023

(30) Foreign Application Priority Data
Oct. 31, 2023 (CN) 202311438035.9

(51) Int. Cl. G05B 19/05

(52) U.S. Cl. CPC G05B 19/052; G05B 19/058

(57) ABSTRACT

Disclosed in the present application is a multi-host system and a method for determining a main controller. The multi-host system includes a first motherboard and a second motherboard, the first motherboard includes a first baseboard management controller (BMC) and a first complex programmable logic device (CPLD), the second motherboard includes a second BMC and a second CPLD. When the first CPLD receives the control request signal from the first BMC and a first signal from the second CPLD, the first BMC is determined to be a main controller of the multi-host system, and the first CPLD outputs a second signal to the second CPLD. The present application can improve the stability and security of the multi-host system.

### FIELD

The present disclosure relates to the technical field of servers, and specifically to a multi-host system and a method for determining a main controller.

### BACKGROUND

In general, a large server is equipped with two or more motherboards to form a multi-host system, and some assembly units in a server chassis, such as a power supply, a fan controller, and other assembly units are shared by the motherboards. Each motherboard will be equipped with a baseboard management controller (BMC), the assembly unit can be controlled by the BMC, and in order to avoid control conflicts between the multiple BMCs, it is necessary to determine a main BMC, and the main BMC controls the assembly unit.

In related technology, by setting an identity document (ID) value on each motherboard and a BMC value on a BMC, when the BMC detects that its own BMC value is equal to the ID value, it determines itself to be the main BMC module and controls the assembly unit in the multi-host system. When the master BMC crashes or stops, the assembly unit will be out of control, and the other BMCs will not be able to control the assembly unit, which ultimately affects the safety and stability of the multi-host system.

Therefore, improvement is desired.

### BRIEF DESCRIPTION OF THE DRAWINGS

FIG. 1 is a schematic diagram illustrating a multi-host system according to an embodiment of the present disclosure.

FIG. 2 is a flowchart illustrating a method for determining a main controller according to an embodiment of the present disclosure.

FIG. 3 is a flowchart illustrating a method for determining a main controller according to another embodiment of the present disclosure.

FIG. 4 is a flowchart illustrating a method for determining a main controller according to another embodiment of the present disclosure.

### DETAILED DESCRIPTION

The technical solutions in the embodiments of the present disclosure will be described below in conjunction with the accompanying drawings in the embodiments of the present disclosure, and it is clear that the embodiments described are only a portion of the embodiments of the present disclosure and not all of them.

In the description of the embodiments of the present disclosure, the technical terms “first,” “second,” and the like are only used to distinguish different objects, and are not to be construed as indicating or implying relative importance, or implicitly specifying the number, specific order, or primary-secondary relationship of the indicated technical features. In the description of the embodiments of the present disclosure, “more than one” means more than two, unless otherwise expressly and specifically limited.

Large servers are set up with two or more motherboards to form a multi-host system, and some assembly units in the server chassis, such as power supplies, fan controllers, and other assembly units are shared by multiple motherboards. Each motherboard will be equipped with a baseboard management controller (BMC), the assembly unit is controlled by the BMC, and in order to avoid control conflicts between multiple BMCs, it is necessary to determine a main BMC, which controls the assembly unit.

In related technology, by setting an ID value on each motherboard and a BMC value on a BMC, when the BMC detects that its own BMC value is equal to the ID value, it determines itself to be the main BMC module and controls the assembly unit in the multi-master system. When the main BMC crashes or stops, the assembly unit will be out of control, and the other BMCs will not be able to control the assembly unit, which ultimately affects the safety and stability of the multi-host system.

The present disclosure provides a multi-master system and a method for determining a main controller. The present application can dynamically determine a main controller in a multi-host system, and in the event that the main controller crashes or stops, another BMC can be determined as the main controller, thereby improving the stability and security of the multi-host system.

Embodiments of the present disclosure are further described below in conjunction with the accompanying drawings.

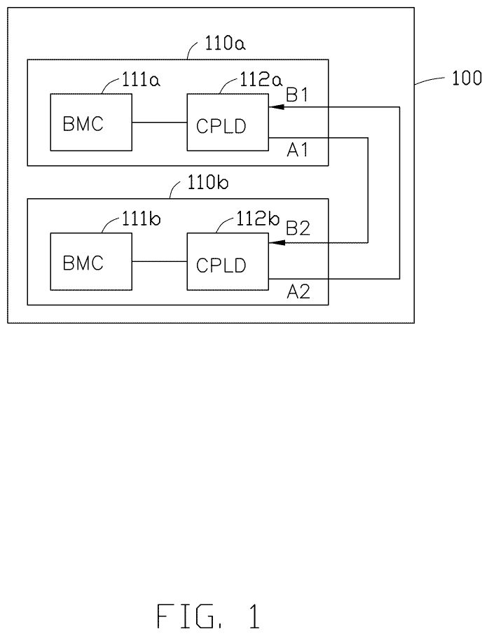

FIG. 1 illustrates a multi-host system 100 in accordance with an embodiment of the present disclosure.

The multi-host system 100 includes at least two motherboards. It can be understood that in the embodiment, two motherboards 110a and 110b are used as examples. In other embodiments, the number of the motherboards can be greater than two.

As shown in FIG. 1, the motherboard 110a includes a BMC 111a and a complex programmable logic device (CPLD) 112a. The motherboard 110b includes a BMC 111b and a CPLD 112b. The BMC 111a is connected to the CPLD 112a, and the BMC 111b is connected to the CPLD 112b.

The CPLD 112a includes a first interface A1 and a second interface B1. The CPLD 112b includes a first interface A2 and a second interface B2. In the embodiment, the first interface A1 of the CPLD 112a is connected to the second interface B2 of the CPLD 112b, and the first interface A2 of the CPLD 112b is connected to the second interface B1 of the CPLD 112a.

In the embodiment of the present application, each BMC is used to transmit a control request signal to a corresponding connected CPLD at preset intervals, to request a control authority from the corresponding CPLD. After a BMC is given control authority, the BMC can control the fan or the power supply in the server.

For example, as shown in FIG. 1, the BMC 111a is used to transmit a first control request signal to the CPLD 112a at preset intervals, to request the control authority from the CPLD 112a. The BMC 111b is used to transmit a second control request signal to the CPLD 112b at preset intervals, to request the control authority from the CPLD 112b.

Each CPLD is used to output a second signal to other CPLDs in response to the control request signal of the corresponding connected BMC and the first signal of other CPLDs and transmit a state signal to the corresponding connected BMC. The state signal can be used to determine that the corresponding connected BMC is a main controller of the multi-host system 100.

For example, as shown in FIG. 1, the first interface A1 of the CPLD 112a can transmit the first signal or the second signal to the CPLD 112b, and the second interface B1 of the CPLD 112a can receive the first signal or the second signal of the CPLD 112b. The first interface A2 of the CPLD 112b can transmit the first signal or the second signal to the CPLD 112a, and the second interface B2 of the CPLD 112b can receive the first signal or the second signal of the CPLD 112a.

After receiving the control request signal from the corresponding BMC, each CPLD will detect the state of its own interface.

For example, the CPLD 112a receives the first control request signal from the BMC 111a, the CPLD 112a will detect the state of the second interface B1. If the first signal is received from the second interface B1, it indicates that the BMC 111b of the motherboard 110b does not have the authority of the main controller. Therefore, the CPLD 112a can control the first interface A1 to output the second signal, so that the CPLD 112b will receive the second signal from the second interface B1 of the CPLD 112a, thus, the BMC 111b will not get the authority of the main controller. The CPLD 112a transmits the first interface state to the BMC 111a to enable the BMC 111a to be identified as a main controller of the multi-host system. The first interface state includes the second interface B1 receiving a first signal and the first interface A1 outputting a second signal.

The present application, by setting a first interface of each CPLD to be connected to a second interface of the other CPLDs, and a second interface of each CPLD to be connected to a first interface of the other CPLDs, and by setting a BMC to request the authority of the main controller at preset intervals, a main BMC can be dynamically determined based on the state of the first interface and the state of the second interface after the control request signal is received by the CPLD, even when the main controller crashes or stops, another BMC can be identified as the main controller, thus improving the stability and safety of the multi-host system.

In the embodiments of the present application, the first signal is a low-level signal, and the second signal is a high-level signal. Alternatively, the first signal is a high-level signal, and the second signal is a low-level signal.

In some embodiments, the BMC 111a is connected to the CPLD 112a through an inter-integrated circuit (I2C) bus, the BMC 111b is connected to the CPLD 112b through the I2C bus.

In some embodiments, the CPLD is further used to: transmit a second interface state to a corresponding BMC in response to the control request signal and a second signal is received by the corresponding first interface, the second interface state is used to identify the corresponding BMC as a backup controller of the multi-host system.

In other words, when the CPLD receives the second signal from other CPLDs through the second interface, then the corresponding BMC of the other CPLD can be determined as the main controller, in order to avoid privilege conflicts, the CPLD transmits the second interface state to the corresponding BMC so that the corresponding BMC is determined to be the backup controller of the multi-host system. The second interface state includes the second interface receiving the second signal and the first interface outputting the first signal.

For example, when the CPLD 112a receives the second signal from the CPLD 112b through the second interface B1, then the BMC 111b can be determined as the main controller, in order to avoid privilege conflict, the CPLD 112a transmits the second interface state to the BMC 111a, so that the BMC 111a is determined to be the backup controller of the multi-host system 100, and the second interface state includes the second interface B1 receiving the second signal and the first interface A1 outputting the first signal.

In some embodiments, the CPLD is also used to control the corresponding first interface to output the first signal when it determines that a time at which the corresponding first interface outputs the second signal is greater than a predetermined time. For example, in a scenario, if the CPLD 112a determines that the time for the first interface A1 to output the second signal is greater than the predetermined time, the first interface A1 of the CPLD 112a is controlled to output the first signal to the second interface B2 of the CPLD 112b. In other words, the CPLD needs to confirm the control request signal of the corresponding BMC again after a predetermined time has elapsed before it can control the output of the second signal from the first interface again, in order to avoid that there is no main controller to control the assembly unit after the corresponding BMC stops working or collapses within the predetermined. Therefore, when the time for the output of the second signal from the first interface A1 of the CPLD 112a is greater than the predetermined time, the CPLD 112a controls first interface A1 to output the first signal to the second interface B2 of the CPLD 112b.

In some embodiments, the CPLD is also used to control the corresponding first interface to output the first signal if the control request signal is not received after the predetermined time. In other words, if the CPLD does not receive a control request signal after a predetermined time, it can be determined that the corresponding BMC stops working or crashes. Then, the CPLD can control the corresponding first interface to output the first signal, so that other CPLDs can control the first interface to output the second signal and switch to the corresponding BMC as the main controller. For example, if the CPLD 112a does not receive a first control request signal after a predetermined time, it can be determined that the BMC 111a stops working or crashes. Then, the CPLD 112a can control the first interface A1 to output the first signal to the second interface B2 of the CPLD 112b, so that the CPLD 112b can control the first interface A2 to output the second signal to the second interface B1 of the CPLD 112a, and the BMC 111b is switched to the main controller of the multi-host system 100.

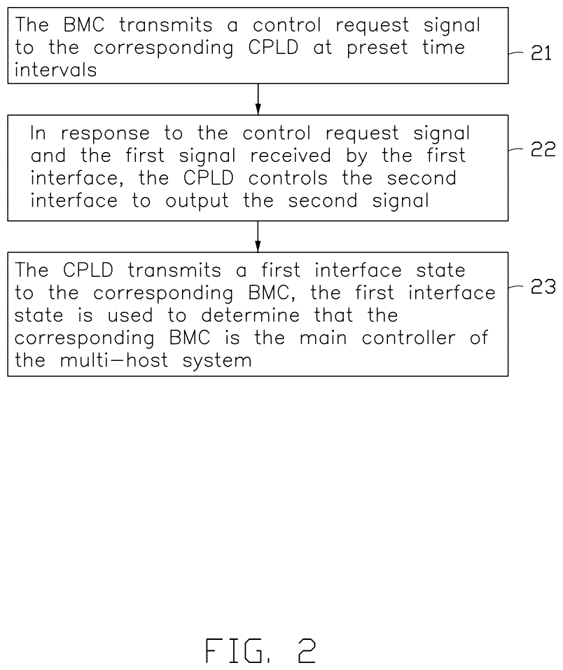

FIG. 2 is a flowchart depicting an embodiment of a method for determining a main controller.

The method for determining a main controller can be applied to the multi-host system 100. The multi-host system 100 includes at least two motherboards, each motherboard includes a BMC and a CPLD, the CPLD includes a first interface and a second interface, the BMC is connected to the CPLD of the same motherboard, the first interface of each CPLD is connected to the second interface of the other CPLD, and the second interface of the CPLD is connected to the first interface of the other CPLD.

As shown in FIG. 1, two motherboards 110a and 110b are used as examples.

Each block shown in FIG. 2 represents one or more processes, methods, or subroutines, carried out in the example method. The example method can begin at block 21.

At block 21, the BMC transmits a control request signal to the corresponding CPLD at preset time intervals.

For example, the BMC 111a transmits a first control request signal to the CPLD 112a at the preset time intervals, and the BMC 111b transmits a second control request signal to the CPLD 112b at the preset time intervals.

At block 22, in response to the control request signal and the first signal received by the second interface, the CPLD controls the first interface to output the second signal.

For example, if the CPLD 112a receives the first control request signal from the BMC 111a and the second interface B1 receives the first signal from the CPLD 112b, the CPLD 112a controls the first interface A1 to output the second signal to the second interface B2 of the CPLD 112b. If the CPLD 112b receives the second control request signal from the BMC 111b and the second interface B2 receives the first signal from the CPLD 112a, the CPLD 112b controls the first interface A2 to output the second signal to the second interface B1 of the CPLD 112a.

At block 23, the CPLD transmits a first interface state to the corresponding BMC, the first interface state is used to determine that the corresponding BMC is the main controller of the multi-host system.

For example, when the CPLD 112a receives the first control request signal from the BMC 111a and the second interface B1 receives the first signal from the CPLD 112b, the CPLD 112a controls the first interface A1 to output the second signal to the second interface B2 of the CPLD 112b, and transmits the first interface state to the BMC 111a, and the first interface state is used to determine that the BMC 111a is the main controller of the multi-host system 100.

The beneficial effects that can be achieved by the method for determining the main controller of the embodiment of the present application can be referred to the beneficial effects of the multi-host system provided above and will not be repeated herein.

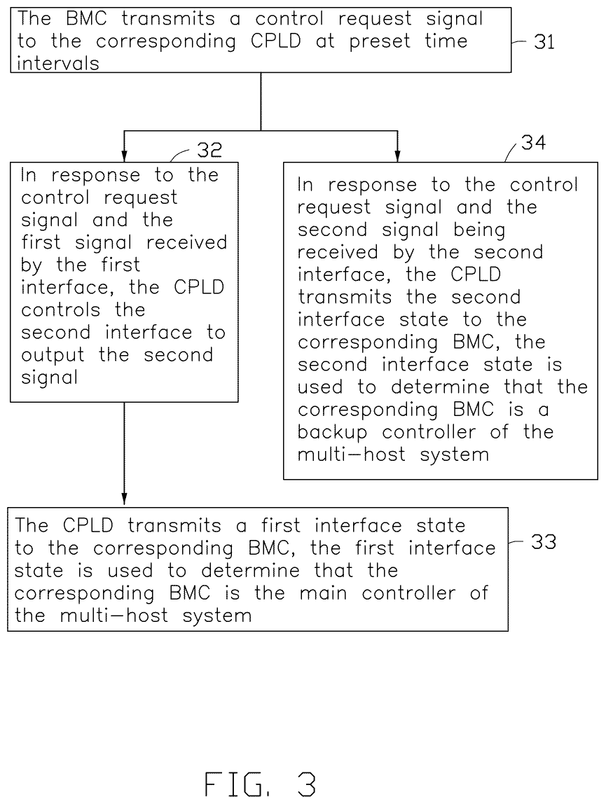

FIG. 3 is a flowchart depicting another embodiment of the method for determining the main controller.

The method for determining the main controller shown in FIG. 3 includes blocks 31 to 33, which are consistent with blocks 21 to 23 shown in FIG. 2.

Each block shown in FIG. 3 represents one or more processes, methods, or subroutines, carried out in the example method. The example method can begin at block 31.

At block 31, the BMC transmits a control request signal to the corresponding CPLD at preset time intervals.

At block 32, in response to the control request signal and the first signal received by the second interface, the CPLD controls the first interface to output the second signal.

At block 33, the CPLD transmits a first interface state to the corresponding BMC, the first interface state is used to determine that the corresponding BMC is the main controller of the multi-host system.

For example, if the CPLD 112a receives the first control request signal from the BMC 111a and the second interface B1 receives the first signal from the CPLD 112b, the CPLD 112a controls the first interface A1 to output the second signal to the second interface B2 of the CPLD 112b, and transmits the first interface state to the BMC 111a, and the first interface state is used to determine that the BMC 111a is the main controller of the multi-host system 100.

At block 34, in response to the control request signal and the second signal being received by the second interface, the CPLD transmits the second interface state to the corresponding BMC, the second interface state is used to determine that the corresponding BMC is a backup controller of the multi-host system.

For example, if the CPLD 112b receives the second control request signal from the BMC 111b and the second interface B2 receives the second signal received from the CPLD 112a, the CPLD 112b transmits the second interface state to the BMC 111b, the second interface state is used to determine that the BMC 111b is a backup controller of the multi-host system 100.

The beneficial effects that can be achieved by the method for determining the main controller of the embodiment of the present application can be referred to the beneficial effects of the multi-host system provided above and will not be repeated herein.

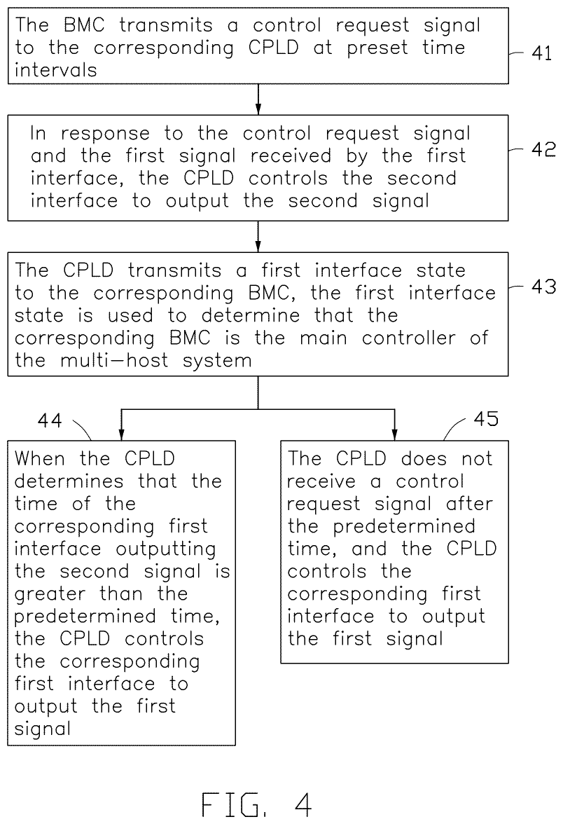

FIG. 4 is a flowchart depicting another embodiment of the method for determining the main controller.

The method for determining the main controller shown in FIG. 4 includes blocks 41 to 43, which are consistent with blocks 21 to 23 shown in FIG. 2.

Each block shown in FIG. 4 represents one or more processes, methods, or subroutines, carried out in the example method. The example method can begin at block 41.

At block 41, the BMC transmits a control request signal to the corresponding CPLD at preset time intervals.

At block 42, in response to the control request signal and the first signal received by the second interface, the CPLD controls the first interface to output the second signal.

At block 43, the CPLD transmits a first interface state to the corresponding BMC, the first interface state is used to determine that the corresponding BMC is the main controller of the multi-host system.

At block 44, when the CPLD determines that the time of the corresponding first interface outputting the second signal is greater than the predetermined time, the CPLD controls the corresponding first interface to output the first signal.

For example, if the CPLD 112a determines that the timing of the second signal output from the first interface A1 is greater than the predetermined time, the CPLD 112a controls the first interface A1 to output the first signal to the second interface B2 of the CPLD 112b, and the BMC 111b is switched to the main controller of the multi-host system 100.

At block 45, the CPLD does not receive a control request signal after the predetermined time and controls the corresponding first interface to output the first signal.

For example, if the CPLD 112a does not receive a first control request signal after the predetermined time, the CPLD 112a controls the first interface A1 to output the first signal to the second interface B2 of the CPLD 112b, and the BMC 111b is switched to the main controller of the multi-host system 100.

The beneficial effects that can be achieved by the method for determining the main controller of the embodiment of the present application can be referred to the beneficial effects of the multi-host system provided above and will not be repeated herein.

The present disclosure also provides a storage medium. The storage medium is a computer readable storage medium. The computer readable storage medium stores computer instructions for executing the method for determining a main controller.

In the above embodiments, this may be implemented in whole or in part by software, hardware, firmware, or any combination thereof. When implemented using software, it may be implemented in whole or in part in the form of a computer program product, the computer program product includes one or more computer instructions. It will be appreciated that loading and executing said computer program instructions on a computer produces, in whole or in part, a process or function in accordance with the processes described in embodiments of the present application. The computer may be a general-purpose computer, a specialized computer, a computer network, or other programmable device. The computer instructions may be stored in a computer storage medium or transmitted through the computer storage medium. The computer instructions may be transmitted from one website site, computer, server, or data center to another website site, computer, server, or data center by wired (e.g., coaxial cable, fiber optic, digital subscriber line (DSL)) or wireless (e.g., infrared, wireless, microwave, etc.) means. The computer storage medium may be any available medium to which a computer has access or a data storage device such as a server, data center, etc. that contains one or more available media integrated. The available medium may be a magnetic medium, an optical medium, or a semiconductor medium.

A person of ordinary skill in the art may understand that realizing all or part of the processes in the methods of the above-described embodiments may be accomplished by instructing the relevant hardware to do so by means of a computer program, which may be stored in a computer-readable storage medium, and which, when executed, may comprise a process such as the process of the embodiments of each of the above-described methods. The aforementioned storage medium may include various media that can store program code such as ROM, RAM, disk, or CD-ROM. The technical features in embodiments may be combined in any combination without conflict.

Those of ordinary skill in the art should realize that the above embodiments are only used to illustrate the present disclosure, but not to limit the present disclosure. As long as they are within the essential spirit of the present disclosure, the above embodiments are appropriately made and changes fall within the scope of protection of the present disclosure.

What is claimed is:

1. A multi-host system comprising:
a first motherboard comprising a first baseboard management controller (BMC) and a first complex programmable logic device (CPLD), the first BMC electrically connected to the first CPLD, wherein the first BMC is configured to transmit a first control request signal to the first CPLD at preset time intervals; and
a second motherboard comprising a second BMC and a second CPLD, the second BMC electrically connected to the second CPLD, and the second CPLD electrically connected to the first CPLD, wherein the second BMC is configured to transmit a second control request signal to the second CPLD at the preset time intervals,
wherein when the first CPLD receives the first control request signal from the first BMC and a first signal from the second CPLD, the first BMC is determined to be a main controller of the multi-host system, and the first CPLD outputs a second signal to the second CPLD.

2. The multi-host system of claim 1, wherein when the second CPLD receives the second control request signal from the second BMC and the second signal from the first CPLD, the second BMC is determined to be a backup controller of the multi-host system.

3. The multi-host system of claim 1, wherein when the first BMC stops working, the first CPLD outputs the first signal to the second CLPD, and when the second CPLD receives the second control request signal from the second BMC and the first signal from the first CPLD, the second BMC is determined to be the main controller of the multi-host system.

4. The multi-host system of claim 1, wherein the first CPLD comprises a first interface and a second interface, the second CPLD comprises a first interface and a second interface, the first interface of the first CPLD is electrically connected to the second interface of the second CPLD, and the first interface of the second CPLD is electrically connected to the second interface of the first CPLD.

5. The multi-host system of claim 4, wherein when the first CPLD receives the first control request signal from the first BMC and the second interface of the first CPLD receives the first signal outputted by the first interface of the second CPLD, the first BMC is determined to be the main controller of the multi-host system, and the first interface of the first CPLD outputs a second signal to the second interface of the second CPLD.

6. The multi-host system of claim 4, wherein when the second CPLD receives the second control request signal from the second BMC and the second interface of the second CPLD receives the second signal from the first interface of the first CPLD, the second BMC is determined to be a backup controller of the multi-host system.

7. The multi-host system of claim 4, wherein when the first BMC stops working, the first interface of the first CPLD outputs the first signal to the second interface of the second CLPD, and when the second CPLD receives the control request signal from the second BMC and the first signal from the first interface of the first CPLD, the second BMC is determined to be the main controller of the multi-host system.

8. The multi-host system of claim 4, wherein when a time for the first interface of the first CPLD to output the second signal is greater than a predetermined time, the first interface of the first CPLD outputs the first signal to the second interface of the second CPLD.

9. The multi-host system of claim 4, wherein when the first CPLD does not receive the first control request signal of the first BMC after a predetermined time, and the first interface of the first CPLD outputs the first signal to the second interface of the second CPLD.

10. The multi-host system of claim 1, wherein the first BMC is connected to the first CPLD through an inter-integrated circuit (I2C) bus, and the second BMC is connected to the second CPLD through the I2C bus.

11. A method for determining a main controller applied to a multi-host system, the multi-host system comprising a first motherboard and a second motherboard, the first motherboard comprising a first baseboard management controller (BMC) and a first complex programmable logic device (CPLD), the second motherboard comprising a second BMC and a second CPLD, the first BMC electrically connected to the first CPLD, and the second BMC electrically connected to the second CPLD, the method comprising:
transmitting a first control request signal to the first CPLD at preset time intervals by the first BMC;
transmitting a second control request signal to the second CPLD at the preset time intervals by the second BMC; and
determining the first BMC as a main controller of the multi-host system when the first CPLD receives the first control request signal from the first BMC and a first signal from the second CPLD, and outputting a second signal to the second CPLD by the first CPLD.

12. The method of claim 11, further comprising:
determining the second BMC as a backup controller of the multi-host system when the second CPLD receives the second control request signal from the second BMC and the second signal from the first CPLD.

13. The method of claim 11, further comprising:
outputting the first signal to the second CLPD by the first CPLD when the first BMC stops working; and
determining the second BMC as the main controller of the multi-host system when the second CPLD receives the second control request signal from the second BMC and the first signal from the first CPLD.

14. The method of claim 11, further comprising:
outputting the first signal to a second interface of the second CPLD by a first interface of the first CPLD when a time for the first interface of the first CPLD to output the second signal is greater than a predetermined time.

15. The method of claim 11, further comprising:
outputting the first signal to a second interface of the second CPLD by a first interface of the first CPLD when the first CPLD does not receive the first control request signal of the first BMC after a predetermined time.

16. The method of claim 11, wherein the first signal is a low-level signal, and the second signal is a high-level signal.

17. The method of claim 11, wherein the second signal is a low-level signal, and the first signal is a high-level signal.
